(19) United States
(12) Patent Application Publication
(10) Pub. No.: US 2026/0347735 A1
(43) Pub. Date: Nov. 5, 2026

(54) METHOD FOR FLAVORING DISTILLED LIQUOR AND SYSTEM FOR THE SAME

(71) Applicant: HAN'S FERMENTATION RESEARCH INSTITUTE CO., LTD, Jeongeup-si Jeonbuk-do (KR)

(72) Inventor: Yeong Seok HAN, Jeongeup-si (KR)

(73) Assignee: HAN'S FERMENTATION RESEARCH INSTITUTE CO., LTD, Jeongeup-si Jeonbuk-do (KR)

(21) Appl. No.: 19/704,503

(22) Filed: Jun. 11, 2026

Related U.S. Application Data
(63) Continuation of application No. PCT/KR2024/020152, filed on Dec. 10, 2024.

(30) Foreign Application Priority Data
Dec. 11, 2023 (KR) 10-2023-0178382

(51) Int. Cl. C12G 3/06

(52) U.S. Cl. CPC C12G 3/06

(57) ABSTRACT

According to embodiments, a method for flavoring distilled liquor includes drying flower buds or herbs, and applying, to distilled liquor through an air pump, air passing through the dried flower buds or herbs, wherein the drying includes drying the flower buds or herbs such that a moisture content thereof decreases by 10% or more and less than 28%.

### CROSS-REFERENCE TO RELATED APPLICATION

This application is a bypass continuation of International Application No. PCT/KR2024/020152, filed on Dec. 10, 2024, which claims priority to and the benefit of Korean Patent Application No. 10-2023-0178382, filed on Dec. 11, 2023. The disclosures of the above-referenced applications are incorporated herein by reference in their entirety.

### TECHNICAL FIELD

The present disclosure relates to a method for flavoring distilled liquor and a system for the same. More specifically, the present disclosure discloses a specific method and system for flavoring distilled liquor with air containing aromas of raw materials, and discloses preferred embodiments of a drying degree of the raw materials and a duration of performing an airing process.

### BACKGROUND

Recently, as living standards have improved and more people seek to enjoy a relaxed lifestyle, interest in distilled liquor has greatly increased. Accordingly, beyond diversification of types of distilled liquor, various techniques for imparting unique aromas to distilled liquor have been actively studied.

Conventionally, methods have been used in which additives for flavoring are added to water used for steaming cooked rice, or flavoring additives are directly added to increase flavor. However, in such flavoring methods using additives, fragrance and color are initially maintained, but, over time, medicinal herb-like odors are generated and the color of the liquor becomes brown.

In addition, methods of applying air to liquor together with a flavoring agent have also been studied. A related background technology is disclosed in Japanese Patent Publication No. 7734967 (2020 Jan. 21). However, even in this case, since a direct flavoring material is applied, the problems in which medicinal herb-like odors are generated over time and the color of the liquor becomes brown still remain unresolved.

Accordingly, the present disclosure has been derived from studies directed to preventing the aroma of liquor from changing into a medicinal herb-like odor and preventing browning of the liquor without directly applying a flavoring agent to the liquor. More specifically, the present disclosure relates to a method of imparting aroma by introducing aromas of fresh flowers through air without directly adding a flavoring material to the liquor.

In addition, the present disclosure has been derived from studies directed to conditions under which aromas of fresh flowers can be sufficiently expressed during a process of introducing the aromas of the fresh flowers through air, and methods for removing grassy odors possessed by the fresh flowers while imparting the aromas.

### SUMMARY

According to embodiments, a method for flavoring distilled liquor may include drying flower buds or herbs, and applying, to distilled liquor, air passing through the dried flower buds or herbs through an air pump, wherein the drying may include drying the flower buds or herbs such that a moisture content thereof decreases by 10% or more and less than 28%.

Further, according to embodiments, the drying may include drying the flower buds or herbs such that a moisture content thereof decreases by 15% or more and less than 20%.

Further, according to embodiments, applying air to the distilled liquor may further include applying air filtered through a filter.

In addition, according to embodiments, the filter may include one or more High Efficiency Particulate Air (HEPA) filters.

Further, according to embodiments, applying air to the distilled liquor may include applying air passing through the flower buds or herbs for 1 hour or more and less than 2 hours.

Further, according to embodiments, applying air to the distilled liquor may include applying air filtered through the filter to the distilled liquor in the form of fine bubbles having a size of 1 to 2 mm.

Meanwhile, according to embodiments, the method for flavoring distilled liquor may further include a circulation step of circulating the applied air such that the air passes through the flower buds or herbs and is reapplied to the distilled liquor.

Further, according to embodiments, the circulation step may further include removing moisture from the circulated air by using charcoal.

Further, according to embodiments, the method for flavoring distilled liquor may further include controlling a temperature of the distilled liquor.

### BRIEF DESCRIPTION OF DRAWINGS

FIG. 1 is a flowchart illustrating an embodiment of a method for flavoring distilled liquor

FIG. 2 is a flowchart illustrating an embodiment of a system for flavoring distilled liquor

FIG. 3 illustrates an example of a configuration for operating a system for flavoring distilled liquor according to embodiments.

FIG. 4 illustrates an example of a configuration of an air circulation pipe included in a system for flavoring distilled liquor according to embodiments.

### DETAILED DESCRIPTION OF THE EMBODIMENTS

The present disclosure may be modified in various ways and may have various embodiments, and thus specific embodiments will be illustrated in the drawings and described in detail herein. However, this is not intended to limit the present disclosure to specific embodiments, and it should be understood that all modifications, equivalents, and substitutes falling within the spirit and technical scope of the present disclosure are included therein. Like reference numerals are used for like elements throughout the drawings.

Terms such as first, second, A, and B may be used to describe various elements, but the elements should not be limited by such terms. These terms are used only for the purpose of distinguishing one element from another element. For example, a first element may be referred to as a second element without departing from the scope of the present disclosure, and similarly, a second element may also be referred to as a first element. The term “and/or” includes any one or any combination of a plurality of related listed items.

When an element is referred to as being “connected” or “coupled” to another element, it should be understood that the element may be directly connected or coupled to the other element, or intervening elements may also be present therebetween. In contrast, when an element is referred to as being “directly connected” or “directly coupled” to another element, it should be understood that no intervening elements are present therebetween.

The terminology used herein is for the purpose of describing particular embodiments only and is not intended to limit the present disclosure. Singular expressions include plural expressions unless the context clearly indicates otherwise. As used herein, terms such as “include” or “have” are intended to indicate the presence of features, numbers, steps, operations, elements, components, parts, or combinations thereof described in the specification, and should not be understood as precluding the presence or addition of one or more other features, numbers, steps, operations, elements, components, parts, or combinations thereof.

Unless otherwise defined, all terms used herein, including technical and scientific terms, have the same meanings as those generally understood by those skilled in the art to which the present disclosure pertains. Terms defined in commonly used dictionaries should be interpreted as having meanings consistent with the meanings in the context of the related art, and should not be interpreted in an idealized or overly formal sense unless expressly defined herein.

The present specification discloses a method for flavoring distilled liquor and a system for the same according to embodiments. The system for flavoring distilled liquor repeatedly applies aromas generated from fresh flower buds or herbs to distilled liquor, thereby flavoring the distilled liquor with the corresponding aromas. For this purpose, according to embodiments, the system for flavoring distilled liquor dries the fresh flower buds or herbs in order to effectively emit aromas therefrom, and applies the aromas emitted from the dried flower buds or herbs to the distilled liquor by using air circulation.

According to embodiments, the system for flavoring distilled liquor discloses improved methods and configurations for efficiently applying air containing aromas to distilled liquor.

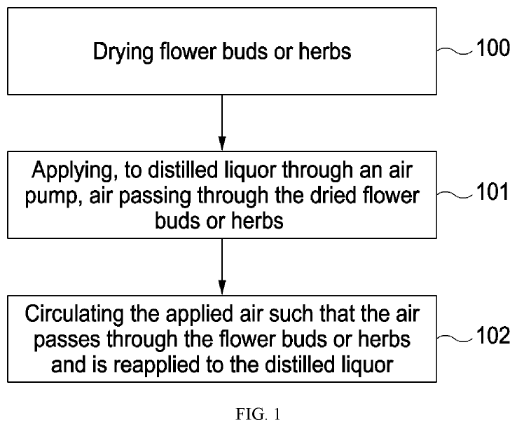

FIG. 1 is a flowchart illustrating an embodiment of a method for flavoring distilled liquor.

A method for flavoring distilled liquor according to embodiments (hereinafter, referred to as a “method according to embodiments”) may include drying flower buds or herbs (100), applying, to distilled liquor through an air pump, air passing through the dried flower buds or herbs (101), and circulating the applied air such that the air passes through the flower buds or herbs and is reapplied to the distilled liquor (102).

Referring to 100 of FIG. 1, drying flower buds or herbs (100) is a process of drying moisture in order to remove unnecessary odors from the flower buds or herbs. When aromas emitted from flower buds or herbs that have not been dried are applied to distilled liquor, there is a problem in that unnecessary grassy odors are also applied together with evaporation of moisture. In order to remove such grassy odors, it is necessary to reduce the moisture content of the flower buds or herbs by a predetermined ratio. Accordingly, the method according to embodiments may dry the flower buds or herbs, and preferably may dry the flower buds or herbs such that a moisture content thereof decreases by 10% or more and less than 28%.

Referring to 101 of FIG. 1, applying, to distilled liquor through an air pump, air passing through the dried flower buds or herbs (101) is a process of applying, to distilled liquor through an air pump, air passing through the dried flower buds or herbs in a state in which the moisture content of the flower buds or herbs is reduced to 10% or more and less than 28%. More specifically, operation 101 is a process of applying, to distilled liquor, air passing through the dried flower buds or herbs, and may include injecting fine air bubbles into the distilled liquor. In operation 101, aroma molecular components included in the fine air bubbles are bonded to alcohol such that the aromas are retained in the liquor.

Meanwhile, when moisture in such raw materials (e.g., flower buds or herbs) is excessively dried, there is a problem in that aromas emitted therefrom are rapidly reduced. Accordingly, when the moisture content of the flower buds or herbs is reduced by 28% or more from an initial state, the method according to embodiments may stop or may not perform operation 101 described above.

Similarly, when moisture in the raw materials is insufficiently dried, aromas emitted therefrom may contain grassy odors caused by moisture, and thus undesirable aromas and tastes may be imparted to the distilled liquor. Accordingly, when the moisture content of the flower buds or herbs is reduced by less than 10% from the initial state, the method according to embodiments may not perform operation 101 described above. The method according to embodiments may continuously perform operation 100 until the moisture content of the flower buds or herbs is reduced by 10% or more and less than 28% from the initial state.

Referring to 102 of FIG. 1, after air containing aromas of the flower buds or herbs is applied to the distilled liquor, the method may further include circulating the applied air such that the air passes through the flower buds or herbs and is reapplied to the distilled liquor (102).

Even when air is injected in step 101, not all aroma molecules emitted from the dried flower buds or herbs may be bonded to alcohol. In addition, in order to flavor the distilled liquor with aromas, air containing the aromas may need to be continuously supplied. The air injected in step 101 rises to the surface of the distilled liquor in the form of air bubbles, and undissolved aromas may escape from the distilled liquor.

In order to prevent the above problem, the method according to embodiments may reuse residual aromas that are not dissolved in the distilled liquor and are discharged to the outside. In order to reuse such residual aromas, the method according to embodiments may circulate the applied air such that the air passes through the flower buds or herbs and is reapplied to the distilled liquor (102).

By performing such an operation, the method according to embodiments enables aromas emitted from raw materials to be used as efficiently as possible.

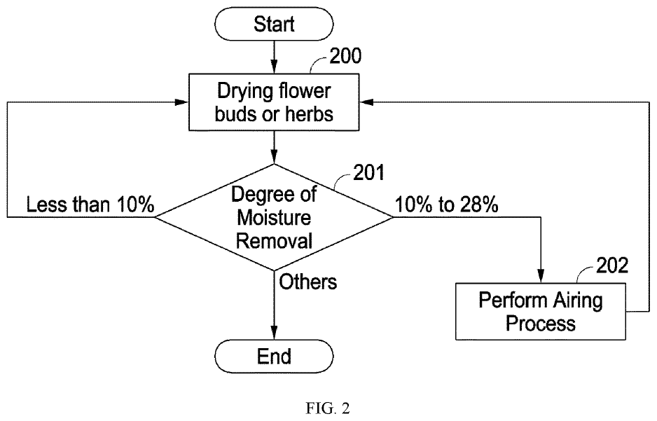

FIG. 2 is a flowchart illustrating an embodiment of a system for flavoring distilled liquor.

More specifically, FIG. 2 illustrates a flowchart of a system performing the operations illustrated in FIG. 1. Some or all of the operations illustrated in FIG. 2 may be performed or controlled by one or more devices and electronic apparatuses associated therewith.

Referring to FIG. 2, first, the system according to embodiments dries flower buds or herbs (200). Operation 200 may be performed by, for example, a separate drying apparatus or a drying unit included in a material container.

According to embodiments, while performing operation 200, the system may identify, in real time, a degree to which moisture in the raw materials has been removed (201). Operation 201 may be performed by, for example, one or more moisture detection sensors included in a drying apparatus or a material container and/or a processor configured to measure moisture (or a degree of reduction in moisture) based on data received from the one or more moisture detection sensors.

The moisture detection sensor may include various sensors. For example, the moisture detection sensor may include a capacitive humidity sensor. The capacitive humidity sensor is a sensor for detecting changes in humidity in air. The capacitive humidity sensor may acquire humidity information around the raw materials in real time and may identify, in real time, a degree of reduction compared to surrounding humidity before drying (201). According to embodiments, the system may identify humidity around the raw materials based on information received from the capacitive humidity sensor, and when the humidity is within a range corresponding to a reduction of 10% to 28% compared to a state before the flower buds or herbs are dried, may perform an airing process (202), which will be described later.

In addition, the moisture detection sensor may include a Normalized Difference Vegetation Index (NDVI) sensor. The NDVI sensor is a sensor used for monitoring a health state of plants, and quantitatively derives a degree of moisture by analyzing an amount and type of light received by the plants.

In addition, the moisture detection sensor may include an electrical resistance measurement sensor. The moisture content of the raw materials affects electrical resistance, and the greater the moisture content, the lower the electrical resistance becomes. Accordingly, the system according to embodiments may measure the electrical resistance of the raw materials in real time (201), and when the electrical resistance is within a range increased by 10% to 28% compared to an initial state, may perform the airing process (202), which will be described later.

According to embodiments, when moisture in the raw materials is reduced by an amount of 10% to 28%, the system performs an airing process (202). The airing process (202) is a process including step 101 and step 102 of FIG. 1. That is, the airing process (202) represents a process of applying aromas emitted from the raw materials to distilled liquor, and circulating the applied air such that the air passes through the flower buds or herbs and is reapplied to the distilled liquor. Meanwhile, even during performance of the airing process (202), moisture in air containing the raw materials may increase, and thus the system according to embodiments continuously dries the flower buds or herbs (200) or maintains humidity.

When moisture in the raw materials is reduced by only about 10% or less, the system according to embodiments does not perform the airing process (202), and continuously dries the flower buds or herbs (200). When moisture in the raw materials is reduced by 28% or more, the system according to embodiments stops the airing process (202), and continuously dries the flower buds or herbs (200).

In some cases, even without a separate moisture sensor, air containing aromas may be applied to the distilled liquor for a limited period of time according to a degree (or duration) of drying.

Due to such a system, the method according to embodiments enables aromas emitted from raw materials to be used as efficiently as possible.

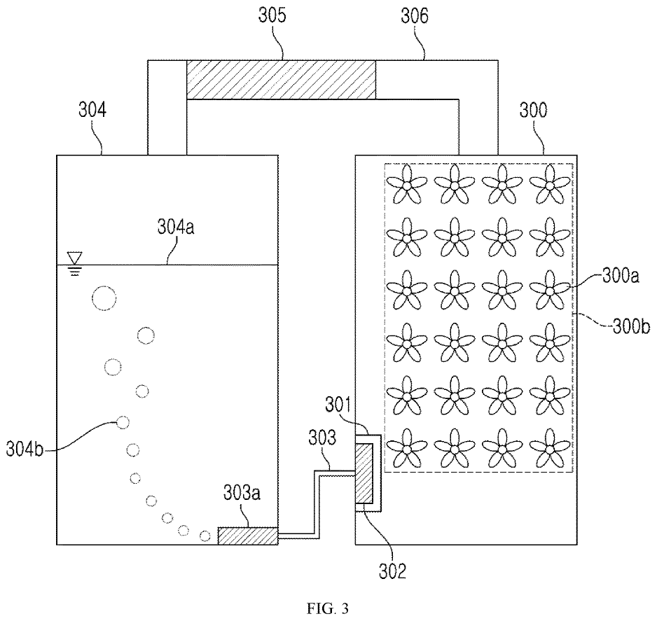

FIG. 3 illustrates an example of a configuration for operating a system for flavoring distilled liquor according to embodiments.

More specifically, FIG. 3 illustrates a configuration diagram of a system for flavoring distilled liquor in which the operations described with reference to FIGS. 1 and 2 are performed.

Referring to FIG. 3, the system for flavoring distilled liquor according to embodiments includes a material container (300), an impurity removal filter (301), an air pump (302), an air connection pipe (303), and a distilled liquor container (304). Additionally, the system for flavoring distilled liquor according to embodiments may include a moisture removal filter (305) and an air circulation pipe (306).

The material container (300) is a container for storing raw materials, and stores fresh flower buds or herbs while providing a space through which circulating air passes during performance of the airing process described with reference to FIGS. 1 and 2. That is, the material container (300) may be a closed container configured such that air circulated through the air circulation pipe (306) passes through the raw materials (300a).

Meanwhile, the raw materials (300a) may be stored in the material container (300) after being dried outside the material container (300), or may be directly dried inside the material container (300). In addition, the material container (300) may further include a drying unit (not shown) such that the raw materials (300a) are stored in a dried environment.

The material container (300) may be formed in a maze structure or a multilayer structure such that circulating air contacts the raw materials (300a) stored in the material container (300) as much as possible.

The impurity removal filter (301) filters impurities (e.g., pollen, soil, dust, and the like) suspended in air entering from the air circulation pipe (306) and passing through (or circulating through) the raw materials. The impurity removal filter (301) filters impurities that should not be introduced into the distilled liquor. The impurity removal filter (301) may be provided so as to surround one end of the air connection pipe (303) through which air moves from the material container (300) to the distilled liquor container (304). The impurity removal filter (301) may be provided so as to surround the air pump (302) disposed at one end of the air connection pipe (303), as illustrated in FIG. 3.

Preferably, the impurity removal filter (301) may include one or more High-Efficiency Particulate Air (HEPA) filters.

The air pump (302) is attached to a surface of the material container (300), and is connected to one end of the air connection pipe (303). The air pump (302) moves air in the material container (300) to the air connection pipe (303) by using power. The air connection pipe (303) may be a communication pipe configured such that air in the material container (300) moves to the distilled liquor container (304) by a driving force of the air pump (302).

Meanwhile, the air pump (302) induces a pressure high enough for air applied to the distilled liquor to generate fine bubbles.

Meanwhile, when the raw materials (300a) are stored in the material container (300) without any fixing device, the raw materials (300a) may become clustered around the air pump (302) due to the driving force of the air pump (302), thereby interfering with circulation of air, and increasing a possibility that impurities pass through the filter (301) and flow into the distilled liquor (304a). Accordingly, according to embodiments, the system may need to prevent the raw materials (300a) in the material container (300) from becoming clustered at a specific location.

Accordingly, the material container (300) according to embodiments may further include a mesh net (300b) surrounding the raw materials (300a). The raw materials (300a) may be contained in the mesh net (300b), and the mesh net (300b) may be fixed or suspended at one position in the material container (300). As another example, the material container (300) may include a fan or a motor at one position, and the mesh net (300b) may be configured to move intermittently or periodically by the fan or motor. By moving the mesh net (300b) intermittently or periodically, flower buds or herbs may be prevented from becoming clustered such that aromas are not properly emitted.

The distilled liquor container (304) is a container for accommodating distilled liquor (304a). A bottom of the distilled liquor container (304) is provided with an air injection unit (303a) connected to the other end of the air connection pipe (303). Air flowing through the air connection pipe (303) is applied to the bottom of the distilled liquor container (304) through the air injection unit (303a). Air applied to the distilled liquor container (304) is applied at a high pressure through the air pump (302).

The distilled liquor container (304) may further include a temperature control unit (not shown) for increasing or decreasing a temperature of the distilled liquor (304a). The temperature control unit cools the temperature of the distilled liquor (304a) such that aromas of the raw materials in the air are more effectively dissolved in the distilled liquor (304a).

Meanwhile, the air injection unit (303a) may include a nozzle, a membrane, or one or more Venturi tubes configured such that air is applied to the distilled liquor (304a) in the distilled liquor container (304) in the form of fine bubbles (304b) having a size of 1 mm or more and less than 2 mm. As another example, the air injection unit (303a) may include ultrasonic nebulizers configured to decompose gas into fine bubbles (304b) by using ultrasound. As another example, the air injection unit (303a) may include an electrostatic atomization module configured to generate fine bubbles (304b) by electrically charging air.

Meanwhile, air discharged from the distilled liquor container (304) includes air (aromas) introduced from the material container (300), but also includes moisture generated by evaporation of the distilled liquor (304a). When air containing such moisture flows again into the material container (300) and contacts the raw materials (300a), aromas and substances causing grassy odors may be applied to the distilled liquor. Accordingly, the moisture removal filter (305) may need to remove moisture before the air introduced from the distilled liquor container (304) flows into the material container (300).

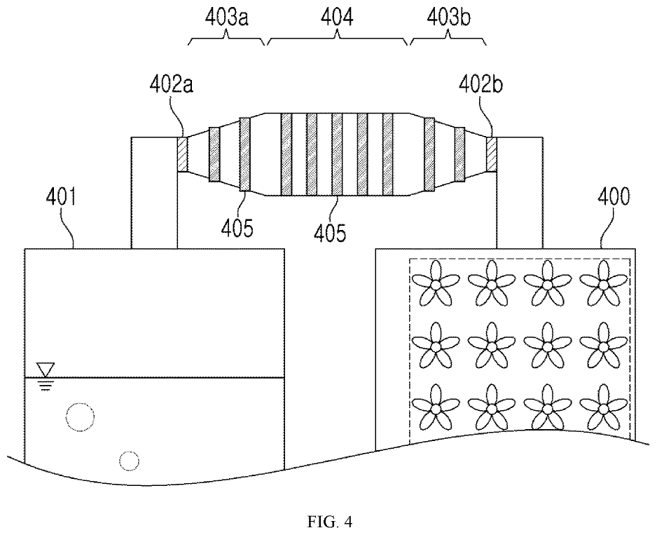

Accordingly, an upper portion of the distilled liquor container (304) is provided with the moisture removal filter (305) or the air circulation pipe (306) connecting with the material container (300), and one or more moisture removal filters (305) are disposed inside the air circulation pipe (306). The moisture removal filter (305) removes moisture from air introduced into an upper end of the distilled liquor container (304). An improved configuration of the air circulation pipe (306) will be described in detail with reference to FIG. 4.

The method according to embodiments enables aromas emitted from raw materials to be used as efficiently as possible.

FIG. 4 illustrates an example of a configuration of an air circulation pipe included in a system for flavoring distilled liquor according to embodiments.

More specifically, FIG. 4 illustrates an example in which the air circulation pipe (306) and the moisture removal filter (305) described with reference to FIG. 3 are provided. Referring to FIG. 4, the air circulation pipe induces circulation by moving air from the distilled liquor container (401) to the material container (400), while simultaneously removing moisture from the air.

Recirculated air contains aroma molecules that are not bonded to alcohol, and thus directly discarding the air may reduce flavoring efficiency. However, when air passing through the distilled liquor is directly applied to the material container (400) while containing moisture, the flower buds and herbs in the material container may become damp and generate unpleasant aromas.

In order to prevent the above problem, air introduced from the distilled liquor container (401) may be air containing moisture due to the distilled liquor, and such air may need to be discharged to the material container (400) after moisture is removed therefrom. Accordingly, the air circulation pipe may include one or more moisture removal filters (405).

Meanwhile, the moisture removal filter (405) may be a filter using charcoal or a filter including a charcoal component.

Meanwhile, when air is applied from the material container (400) to the distilled liquor container (401), the air may be applied at a high speed, whereas air passing through the air circulation pipe requires time until moisture is sufficiently removed. Accordingly, the air circulation pipe may need to reduce a speed of the air such that moisture can be sufficiently removed while the air flows therethrough.

Accordingly, referring to FIG. 4, the air circulation pipe includes an expansion part (403a) having an increasing width as the expansion portion becomes farther from an air inlet (402a), a communication part (404) having a constant width, and a contraction part (403b) having a decreasing width as the contraction portion becomes closer to an air outlet (402b).

In the expansion part (403a), a velocity of air decreases according to Bernoulli's principle. In this case, one or more moisture removal filters may also be provided in the expansion part (403a). The communication part (404) includes one or more moisture removal filters (405). In the communication part (404), air passes through the moisture removal filters at a constant velocity. In the contraction part (403b), a velocity of air increases according to Bernoulli's principle. In this case, one or more moisture removal filters may also be provided in the contraction part (403b).

Preferably, in the expansion part (403a) and the contraction part (403b), the moisture removal filters (405) may be more densely arranged in sections having a greater width. That is, in the expansion part (403a), the moisture removal filters (405) may be more densely distributed at positions closer to the communication part (404), and in the contraction part (403b), the moisture removal filters (405) may also be more densely distributed at positions closer to the communication part (404).

With such a configuration, the system according to embodiments helps continuously perform the airing process while preventing grassy odors and tastes from being imparted to the distilled liquor by maintaining a velocity suitable for removing moisture from circulating air.

Hereinafter, preferred embodiments of a degree of drying the raw materials and a duration of performing the airing process will be described.

In a process of drying raw materials (e.g., 100 of FIG. 1 and 200 of FIG. 2), a method (or system) according to preferred embodiments dries the raw materials by 10% to 28%. When the airing process (e.g., 101 and 102 of FIG. 1 and 202 of FIG. 2) is performed in a state in which moisture is removed by 10% to 28% from the raw materials immediately after extraction from fresh flowers, overall preference was high. In addition, the method (or system) according to preferred embodiments performs the airing process for 1 hour or more and 2 hours or less. Hereinafter, preferred embodiments will be verified by comparing nine embodiments and comparative examples.

Descriptions of the respective embodiments described in [Table 1] and [Table 3] are as follows.

Embodiment 1: Raw materials are dried by less than 10% compared to an initial state, and the airing process is performed for 60 minutes.

Embodiment 2: Raw materials are dried by less than 10% compared to an initial state, and the airing process is performed for 120 minutes.

Embodiment 3: Raw materials are dried by less than 10% compared to an initial state, and the airing process is performed for 180 minutes.

Embodiment 4: Raw materials are dried by 10% or more and less than 28% compared to an initial state, and the airing process is performed for 60 minutes.

Embodiment 5: Raw materials are dried by 10% or more and less than 28% compared to an initial state, and the airing process is performed for 120 minutes.

Embodiment 6: Raw materials are dried by 10% or more and less than 28% compared to an initial state, and the airing process is performed for 180 minutes.

Embodiment 7: Raw materials are dried by 28% or more and less than 35% compared to an initial state, and the airing process is performed for 60 minutes.

Embodiment 8: Raw materials are dried by 28% or more and less than 35% compared to an initial state, and the airing process is performed for 120 minutes.

Embodiment 9: Raw materials are dried by 28% or more and less than 35% compared to an initial state, and the airing process is performed for 180 minutes.

Comparative Example 1: Raw materials are used to flavor distilled liquor by an immersion method.

TABLE 1

| | | | Unpleasantness | Overall |
|---|---|---|---|---|
| Classification | Texture | Aroma | Index | Preference |
| Embodiment 1 (Drying by less than | 7.7 | 5.5 | 6.7 | 6.5 |
| 10% + Airing for 60 minutes) | | | | |
| Embodiment 2 (Drying by less than | 8.2 | 8.0 | 7.3 | 8.8 |
| 10% + Airing for 120 minutes) | | | | |
| Embodiment 3 (Drying by less than | 8.2 | 8.2 | 9.2 | 7.2 |
| 10% + Airing for 180 minutes) | | | | |
| Embodiment 4 (Drying by 10% to | 7.3 | 6.7 | 2.2 | 11.8 |
| 28% + Airing for 60 minutes) | | | | |
| Embodiment 5 (Drying by 10% to | 8.3 | 7.9 | 3.3 | 12.8 |
| 28% + Airing for 120 minutes) | | | | |
| Embodiment 6 (Drying by 10% to | 7.5 | 8.8 | 4.8 | 9.5 |
| 28% + Airing for 180 minutes) | | | | |
| Embodiment 7 (Drying by 28% to | 7.0 | 2.8 | 1.3 | 8.5 |
| 35% + Airing for 60 minutes) | | | | |
| Embodiment 8 (Drying by 28% to | 7.4 | 3.4 | 2.7 | 8.2 |
| 35% + Airing for 120 minutes) | | | | |
| Embodiment 9 (Drying by 28% to | 7.1 | 3.8 | 5.6 | 5.4 |
| 35% + Airing for 180 minutes) | | | | |
| Comparative Example 1 | 5.5 | 6.8 | 4.5 | 7.8 |
| (Immersion) | | | | |

Referring to [Table 1], when the drying and airing processes were performed, texture was generally improved compared to the immersion method.

First, a degree of drying of the raw materials, texture, aroma, unpleasantness index, and overall preference considering these factors are analyzed. The overall preference is calculated by subtracting the unpleasantness index score from a sum of the texture score and the aroma score. In addition, the texture, aroma, and unpleasantness index are each evaluated on a scale from 0 to 10 points.

A degree of flavoring (aroma score) was proportional to a duration of performing the airing process, and the highest scores were observed in Embodiments 2 to 4. In a state in which drying was insufficiently performed (Embodiments 1 to 3), the degree of flavoring was low and the unpleasantness index was high, which is understood as meaning that, rather than inherent aromas of the raw materials, other aromas and grassy odors contained in the raw materials were also applied to the distilled liquor. In a state in which drying was excessively performed (Embodiments 7 to 9), the unpleasantness index, such as grassy odors, was low, but the degree of flavoring was also low, which is understood as resulting from performing the airing process in a state in which inherent aromas of the raw materials had also disappeared.

Accordingly, preferred embodiments are characterized in that airing is performed in a state in which the raw materials are dried by 10% or more and less than 28%.

In addition, it is considered that the longer the duration of the airing process, the more inherent aromas of the raw materials are imparted to the distilled liquor. However, when the duration of the airing process becomes longer, grassy odors contained in the raw materials are also imparted together, thereby negatively affecting the overall score. Referring to [Table 1], the highest overall score was observed when the airing process was performed for 1 hour to 2 hours. Accordingly, preferred embodiments are characterized in that the airing process is performed for 1 hour to 2 hours.

TABLE 2

| Classification | 1 day | 10 days | 20 days | 30 days |
|---|---|---|---|---|
| Embodiment 1 (Drying by less than | 3.2 | 3.6 | 3.2 | 2.2 |
| 10% + Airing for 60 minutes) | | | | |
| Embodiment 2 (Drying by less than | 3.5 | 3.0 | 2.6 | 2.4 |
| 10% + Airing for 120 minutes) | | | | |
| Embodiment 3 (Drying by less than | 3.3 | 3.4 | 2.8 | 2.0 |
| 10% + Airing for 180 minutes) | | | | |
| Embodiment 4 (Drying by 10% to | 4.2 | 4.5 | 4.3 | 3.8 |
| 28% + Airing for 60 minutes) | | | | |
| Embodiment 5 (Drying by 10% to | 4.8 | 4.1 | 4.3 | 3.4 |
| 28% + Airing for 120 minutes) | | | | |
| Embodiment 6 (Drying by 10% to | 4.3 | 4.3 | 2.8 | 2.6 |
| 28% + Airing for 180 minutes) | | | | |
| Embodiment 7 (Drying by 28% to | 4.0 | 3.0 | 2.7 | 2.7 |
| 35% + Airing for 60 minutes) | | | | |
| Embodiment 8 (Drying by 28% to | 4.2 | 3.8 | 2.5 | 2.6 |
| 35% + Airing for 120 minutes) | | | | |
| Embodiment 9 (Drying by 28% to | 4.0 | 3.4 | 1.8 | 2.2 |
| 35% + Airing for 180 minutes) | | | | |
| Comparative Example 1 | 4.8 | 3.7 | 1.8 | 1.3 |
| (Immersion) | | | | |

[Table 2] shows a correlation between a storage period (1 day, 10 days, 20 days, and 30 days) and sensory scores of the above-described embodiments. The sensory scores were evaluated on a 5-point scale.

Referring to [Table 2], when the raw materials were dried by 10% to 28% (Embodiments 4 to 6), favorable sensory scores were observed, although no significant difference was observed compared to other embodiments. However, even when the storage period became longer, the sensory scores of Embodiments 4 to 6 did not significantly decrease, whereas the sensory scores of the other embodiments significantly decreased.

Accordingly, according to [Table 2], preferred embodiments for manufacturing flavored distilled liquor such that the flavored distilled liquor can be stored for a long period are Embodiments 4 to 6.

Furthermore, in Embodiments 4 and 5 described above, overall preference obtained by further specifying the degree of drying is shown in [Table 3] below.

TABLE 3

| | | | Unpleasantness | Overall |
|---|---|---|---|---|
| Classification | Texture | Aroma | Index | Preference |
| Embodiment 10 (Drying by 10% to | 7.3 | 5.5 | 1.8 | 11.0 |
| 15% + Airing for 60 minutes) | | | | |
| Embodiment 11 (Drying by 10% to | 7.3 | 7.1 | 2.0 | 12.4 |
| 15% + Airing for 120 minutes) | | | | |
| Embodiment 12 (Drying by 15% to | 8.3 | 8.0 | 1.7 | 14.6 |
| 20% + Airing for 60 minutes) | | | | |
| Embodiment 13 (Drying by 15% to | 8.1 | 9.4 | 1.3 | 16.2 |
| 20% + Airing for 120 minutes) | | | | |
| Embodiment 14 (Drying by 20% to | 7.3 | 7.4 | 3.5 | 11.2 |
| 28% + Airing for 60 minutes) | | | | |
| Embodiment 15 (Drying by 20% to | 7.7 | 7.5 | 2.9 | 12.3 |
| 28% + Airing for 120 minutes) | | | | |

Referring to [Table 3], among the drying ranges of 10% to 28%, particularly high overall preference was observed in the drying range of 15% to 20%, and the unpleasantness index associated with grassy odors was also evaluated to be meaningfully lower than those of the other embodiments. Accordingly, more preferred embodiments are Embodiments 12 and 13.

The embodiments of the present disclosure disclosed in the present specification and drawings are merely presented as specific examples in order to easily explain the technical features of the present disclosure and to assist understanding of the present disclosure, and are not intended to limit the scope of the present disclosure. In addition to the embodiments disclosed herein, it will be apparent to those skilled in the art that other modified embodiments based on the technical spirit of the present disclosure may also be implemented.

Although preferred embodiments of the present disclosure have been described above with reference to the accompanying drawings, those skilled in the art will appreciate that the present disclosure may be variously modified and changed without departing from the spirit and scope of the present disclosure as defined in the appended claims.

What is claimed is:

1. A method for flavoring distilled liquor, comprising:
drying flower buds or herbs; and
applying, to distilled liquor, air passing through the dried flower buds or herbs through an air pump,
wherein the drying step comprises drying the flower buds or herbs such that a moisture content thereof decreases by 10% or more and less than 28%.

2. The method for flavoring distilled liquor according to claim 1,
wherein the drying step comprises drying the flower buds or herbs such that a moisture content thereof decreases by 15% or more and less than 20%.

3. The method for flavoring distilled liquor according to claim 1,
wherein the applying step further comprises applying air filtered through a filter.

4. The method for flavoring distilled liquor according to claim 3,
wherein the filter comprises one or more High Efficiency Particulate Air (HEPA) filters.

5. The method for flavoring distilled liquor according to claim 1,
wherein the applying step comprises applying air passing through the flower buds or herbs for 1 hour or more and less than 2 hours.

6. The method for flavoring distilled liquor according to claim 3,
wherein the applying step comprises applying air filtered through the filter to the distilled liquor in the form of fine bubbles having a size of 1 to 2 mm.

7. The method for flavoring distilled liquor according to claim 1,
wherein the method for flavoring distilled liquor further comprises a circulation step of circulating the applied air such that the air passes through the flower buds or herbs and is reapplied to the distilled liquor.

8. The method for flavoring distilled liquor according to claim 7,
wherein the circulation step further comprises removing moisture from the circulated air by using charcoal.

9. The method for flavoring distilled liquor according to claim 1,
wherein the method for flavoring distilled liquor further comprises a temperature control step of controlling a temperature of the distilled liquor.

10. A system for flavoring distilled liquor, comprising:
a distilled liquor container configured to accommodate distilled liquor;
a material container configured to accommodate dried flower buds or herbs;
an airing unit configured to apply, to the distilled liquor container through an air pump, air passing through the dried flower buds or herbs in the material container;
an air circulation pipe configured to circulate the air applied through the airing unit to the material container; and
a moisture removal filter configured to remove moisture from the circulated air,
wherein the flower buds or herbs contained in the material container are used in a state in which a moisture content thereof decreases by 10% or more and less than 28%.
